(19) United States
(12) Patent Application Publication
(10) Pub. No.: US 2026/0359248 A1
(43) Pub. Date: Nov. 12, 2026

(54) COMPUTER HOST

(71) Applicant: ASUSTEK COMPUTER INC., TAIPEI (TW)

(72) Inventors: Cheng-Ting HUANG, TAIPEI (TW); Shu-Han HU, TAIPEI (TW); Kuan-Yi LIN, TAIPEI (TW)

(21) Appl. No.: 19/367,547

(22) Filed: Oct. 23, 2025

(30) Foreign Application Priority Data
May 9, 2025 (TW) 114204692

(51) Int. Cl. G06F 13/40; G06F 13/42

(52) U.S. Cl. CPC G06F 13/4068; G06F 13/4221; G06F 2213/0042

(57) ABSTRACT

The computer host provided includes a main board, a hub board, and an expansion device. The main board includes a main board wireless transmission module, where the main board wireless transmission module is adapted for generating a wireless control signal. The hub board includes a hub board wireless transmission module and an expansion connector. The hub board wireless transmission module is electrically connected to the main board wireless transmission module in a wireless manner, and is adapted for receiving a wireless control signal and generating a wired control signal based on the wireless control signal. The expansion connector is electrically connected to the hub board wireless transmission module, and is adapted for transmitting the wired control signal. The expansion device is electrically connected to the expansion connector in a wired manner, and is adapted for receiving the wired control signal and operating based on the wired control signal.

### CROSS-REFERENCE TO RELATED APPLICATIONS

This application claims the priority benefit of Taiwan Application Serial No. 114204692, filed on May 9, 2025. The entirety of the above-mentioned patent application is hereby incorporated by reference herein and made a part of the specification.

### BACKGROUND OF THE INVENTION

### Field of the Invention

The disclosure relates to a computer host, and in particular, to a computer host configured with a hub board.

### Description of the Related Art

Currently, a computer host on the market is usually connected to an expansion device, such as a heat dissipation fan, by using a hub board, to expand a function of a main board. However, a conventional hub board operates by connecting a physical connector of the main board in a wired manner. Therefore, a quantity of hub boards to which the main board can be connected is limited by a quantity of physical connectors, and cannot meet actual application requirements.

### BRIEF SUMMARY OF THE INVENTION

The disclosure provides a computer host. The computer host includes a main board, a hub board, and an expansion device. The main board includes a main board wireless transmission module, where the main board wireless transmission module is adapted for generating a wireless control signal. The hub board includes a hub board wireless transmission module and an expansion connector. The hub board wireless transmission module is electrically connected to the main board wireless transmission module in a wireless manner, and is adapted for receiving a wireless control signal and generating a wired control signal based on the wireless control signal. The expansion connector is electrically connected to the hub board wireless transmission module, and is adapted for transmitting the wired control signal. The expansion device is electrically connected to the expansion connector in a wired manner, and is adapted for receiving the wired control signal and operating based on the wired control signal.

In conclusion, according to the computer host provided in the disclosure, a main board may be connected to a hub board (or an expansion device) in a wireless connection manner instead of a conventional wired connection manner. In this way, connection lines between the hub board and the main board may be simplified, to avoid that excessive connection lines between the hub board and the main board cause difficulty in disassembling and assembling internal components and affect an internal heat dissipation effect and an overall appearance of the computer host.

### BRIEF DESCRIPTION OF THE DRAWINGS

FIG. 1 is a schematic block diagram of a computer host according to a first embodiment of the disclosure;

FIG. 2 is a schematic block diagram of a computer host according to a second embodiment of the disclosure;

FIG. 3 is a schematic block diagram of a computer host according to a third embodiment of the disclosure; and

FIG. 4 is a schematic block diagram of a computer host according to a fourth embodiment of the disclosure.

### DETAILED DESCRIPTION OF THE EMBODIMENTS

More detailed descriptions of specific embodiments of the disclosure are provided below with reference to the schematic diagrams. Advantages and features of the disclosure are described more clearly according to the following description and scope of patent application. It should be noted that all of the drawings use very simplified forms and imprecise proportions, only for the purpose of assisting in conveniently and clearly explaining the embodiments of the disclosure.

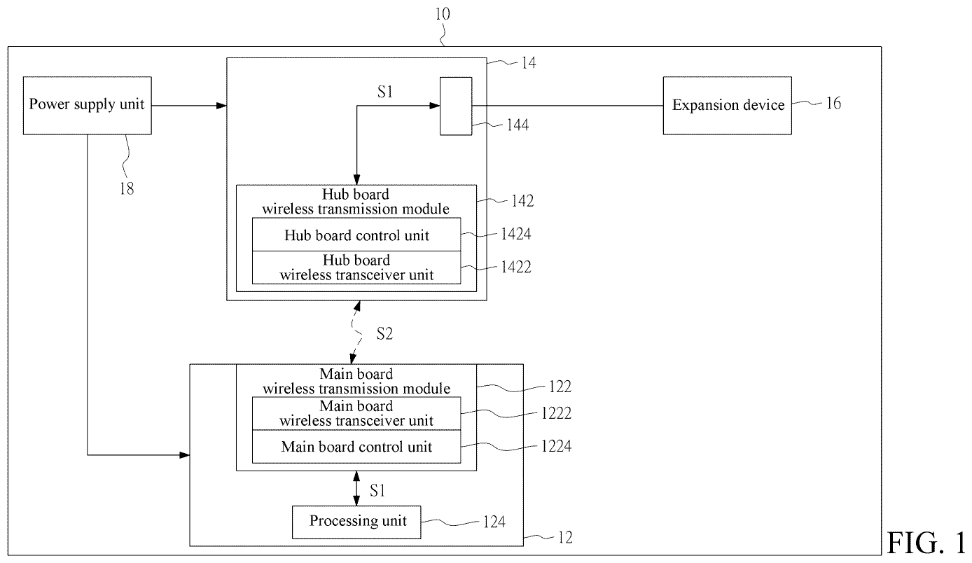

FIG. 1 is a schematic block diagram of a computer host 10 according to a first embodiment of the disclosure.

As shown in the figure, the computer host 10 includes a main board 12, a hub board 14, an expansion device 16, and a power supply unit 18.

The main board 12 includes a main board wireless transmission module 122 and a processing unit 124.

The processing unit 124 is electrically connected to the main board wireless transmission module 122, and is adapted for generating a wired control signal S1. The main board wireless transmission module 122 is adapted for receiving the wired control signal S1, and generating a wireless control signal S2 based on the wired control signal S1. In an embodiment, the processing unit 124 is electrically connected to the main board wireless transmission module 122 through a universal serial bus (USB) 2.0 interface.

In an embodiment, the main board wireless transmission module 122 may include a main board transceiver unit 1222 and a main board control unit 1224. The main board control unit 1224 is adapted for receiving the wired control signal S1, and converting the wired control signal S1 into the wireless control signal S2. The main board transceiver unit 1222 is adapted for transmitting the wireless control signal S2 to the outside. In an embodiment, the main board control unit 1224 may be a microcontroller. Further, in an embodiment, the main board transceiver unit 1222 and the main board control unit 1224 may be integrated into a single component.

The hub board 14 includes a hub board wireless transmission module 142 and an expansion connector 144. The hub board wireless transmission module 142 is electrically paired in a wireless manner with and is connected to the main board wireless transmission module 122, and is adapted for receiving the wireless control signal S2 and generating the wired control signal S1 based on the wireless control signal S2.

In an embodiment, the main board wireless transmission module 122 communicates with the hub board wireless transmission module 142 through a proprietary radio frequency protocol, so as to avoid being interfered and avoid that the hub board is incorrectly connected to another electronic device, thereby improving communication security. Alternatively, a Bluetooth protocol or a Wi-Fi direct technology may be used for communication. In another embodiment, the main board wireless transmission module 122 may alternatively communicate with the hub board wireless transmission module 142 through a standard radio frequency protocol such as Bluetooth, so as to simplify a hub board installation program and facilitate installation and use by a user.

In an embodiment, the hub board wireless transmission module 142 may include a hub board transceiver unit 1422 and a hub board control unit 1424. The hub board transceiver unit 1422 is adapted for receiving the wireless control signal S2, and the hub board control unit 1424 is adapted for converting the wireless control signal S2 into a corresponding wired control signal S1. In an embodiment, the hub board control unit 1424 may be a microcontroller. Further, in an embodiment, the hub board transceiver unit 1422 and hub board control unit 1424 may be integrated into a single component.

The expansion connector 144 is electrically connected to the hub board wireless transmission module 142, and is adapted for receiving the wired control signal S1 and transmitting the wired control signal S1 to the outside.

The expansion device 16 is electrically connected to the expansion connector 144 in a wired manner, and is adapted for receiving the wired control signal S1 and operating based on the wired control signal S1. In an embodiment, the expansion device 16 may be a heat dissipation fan, a control panel, or a light effect module. In an embodiment, the expansion connector 144 may be a fan four-pin connector, an addressable RGB connector (ARGB), a front panel connector, and an audio jack connector (for example, a 3.5 mm AUDIO jack).

The power supply unit 18 is electrically connected to the main board 12 and the hub board 14, and is adapted for supplying power to the main board 12 and the hub board 14. In an embodiment, the power supply unit 18 supplies power to the main board 12 and the hub board 14 through two independent power lines respectively, and then supplies power to the expansion device 16 through the hub board 14. In another embodiment, the power supply unit 18 may alternatively separately supply power to the main board 12, the hub board 14, and the expansion device 16, that is, the expansion device 16 directly obtains power from the power supply unit 18 rather than indirectly obtains power through the hub board 14.

In addition, only one expansion device 16 is disposed for the computer host 10 in this embodiment. In another embodiment, a plurality of expansion devices 16 may alternatively be disposed in the computer host 10, and these expansion devices 16 are connected to a same hub board 14, and then communicate with the main board 12 in a wireless manner through the hub board 14. In addition, in terms of a disposition position, in an embodiment, the hub board 14 is disposed on a front side of the computer host 10, and is neighboring to the expansion device 16.

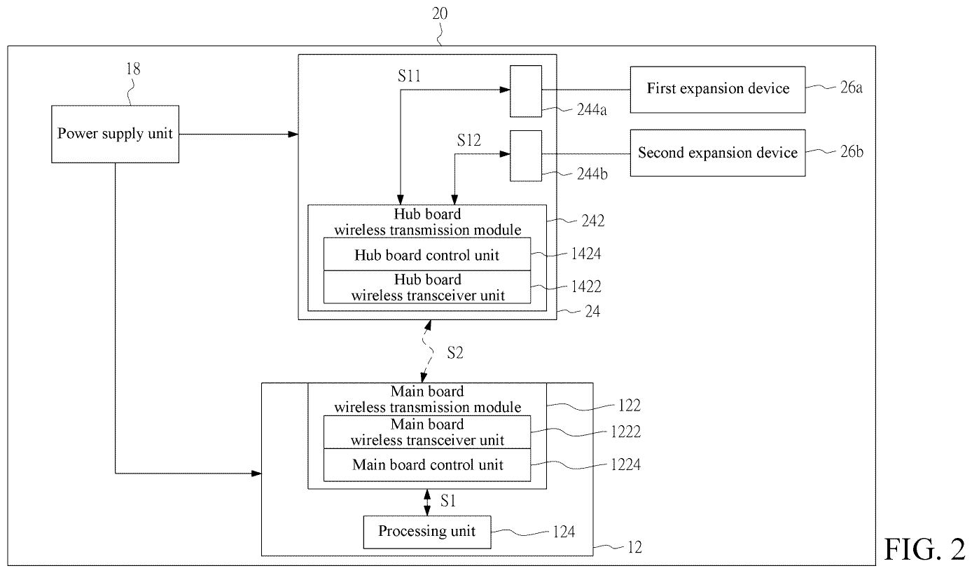

FIG. 2 is a schematic block diagram of a computer host 20 according to another embodiment of the disclosure.

A main difference between this embodiment and the embodiment in FIG. 1 lies in a quantity of expansion devices 16 connected to the hub board 14.

In comparison with the embodiment in FIG. 1, a first expansion device 26a and a second expansion device 26b are disposed for the computer host 20 of this embodiment. The hub board 24 includes a first expansion connector 244a and a second expansion connector 244b, which are respectively configured to connect to the first expansion device 26a and the second expansion device 26b in a wired manner. The hub board wireless transmission module 242 is adapted for generating a first wired control signal S11 and a second wired control signal S12 based on the wireless control signal S2. In an embodiment, the first expansion connector 244a and the second expansion connector 244b may be different connectors.

The first expansion device 26a is electrically connected to the first expansion connector 244a in a wired manner, and is adapted for receiving the first wired control signal S11 and operating based on the first wired control signal S11. The second expansion device 26b is electrically connected to the second expansion connector 244b in a wired manner, and is adapted for receiving the second wired control signal S12 and operating based on the second wired control signal S12.

In an embodiment, the first expansion device 26a may be a fan, and the second expansion device 26b may be a light effect module.

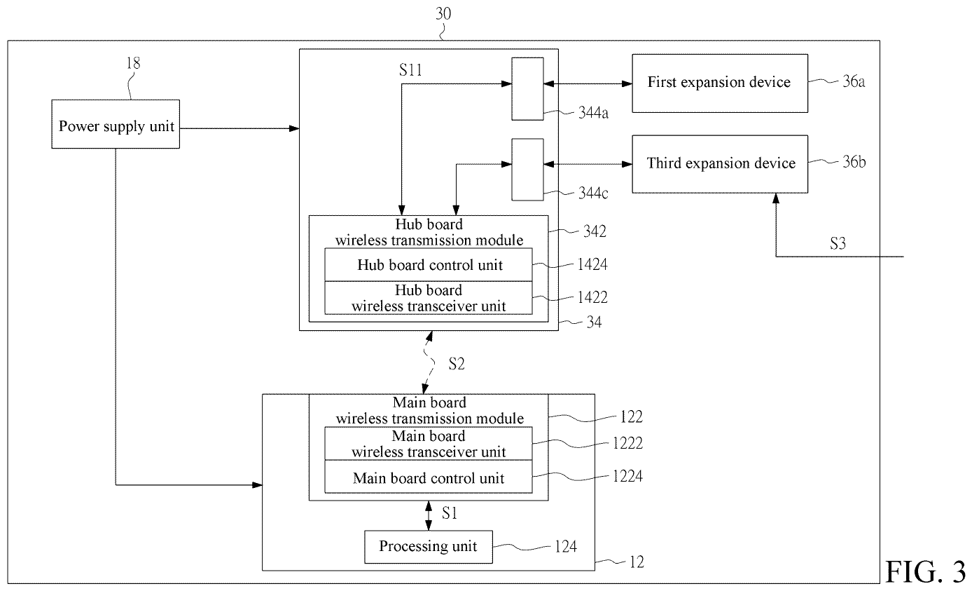

FIG. 3 is a schematic block diagram of a computer host 30 according to still another embodiment of the disclosure.

Similar to the embodiment in FIG. 2, the hub board 34 in this embodiment is also connected to two expansion devices in a wireless manner, that is, a first expansion device 36a and a third expansion device 36c.

However, different from the embodiment in FIG. 2, the first expansion device 26a receives the first wired control signal S11 and operates based on the first wired control signal S11, and the second expansion device 26b receives the second wired control signal S12 from the hub board 24 and operates based on the second wired control signal S12.

The first expansion device 36a in this embodiment is electrically connected to the first expansion connector 344a in a wired manner, and is adapted for receiving the first wired control signal S11 from the hub board 34 and operating based on the first wired control signal S11. However, the third expansion device 36c receives an external control signal S3, transmits the external control signal S3 to the hub board 34 through a third expansion connector 344c, and then transmits, in a wireless manner, the external control signal S3 to the main board 12 through the hub board wireless transmission module 342 for processing.

Specifically, the hub board wireless transmission module 342 converts the external control signal S3 into a wireless signal, and then transmits the wireless signal to the main board 12. After receiving the wireless signal, the main board wireless transmission module 122 converts the wireless signal to generate a corresponding control signal, and then transmits the control signal to the processing unit 124 for subsequent processing.

In an embodiment, the first expansion device 36a is a fan, and the third expansion device 36c may be a control panel. The control panel may be controlled by the user, and is configured to display a status signal to prompt the user. In an embodiment, a power switch, a reset switch, a hard disk status light-emitting diode, and a power status light-emitting diode may be disposed on the control panel. In terms of a disposition position, the control panel may be disposed at a front side of a housing of the computer host 30.

Other components such as the first expansion device 36a and the first expansion connector 344a in this embodiment are similar to corresponding components in FIG. 2, and details are not described herein again.

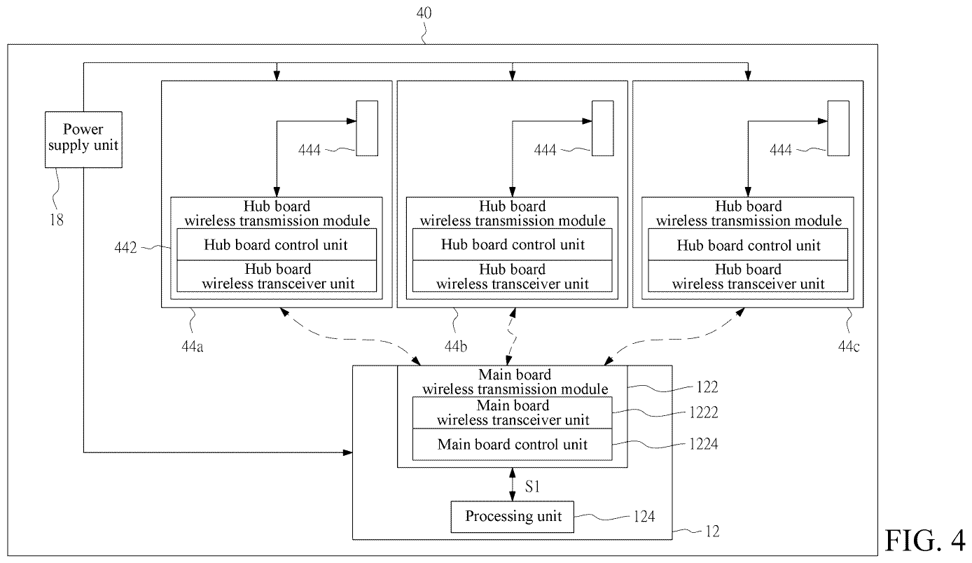

FIG. 4 is a schematic block diagram of a computer host 40 according to a fourth embodiment of the disclosure.

A main difference between this embodiment and the embodiment in FIG. 1 lies in a quantity of hub boards 14, 44a, 44b, and 44c connected to the main board 12. In comparison with the embodiment in FIG. 1, only a single hub board 14 is disposed in the computer host 10. In the computer host 40 of this embodiment, a plurality of hub boards 44a, 44b, and 44c (three hub boards are used as an example in the figure) is disposed.

Each of the hub boards 44a, 44b, and 44c includes a hub board wireless transmission module 442 and an expansion connector 444 (only the hub board 44a is marked in the figure). The processing unit 124 of the main board 12 performs bidirectional communication with each of the hub boards 44a, 44b, and 44c in a wireless connection manner through the main board wireless transmission module 122.

Each of the hub boards 44a, 44b, and 44c may be connected to an expansion device (not shown in the figure) in a wired manner through the expansion connector 444 thereof. The expansion device connected to the hub boards 44a, 44b, and 44c may be, for example, a heat dissipation fan, a control panel, or a light effect module.

The power supply unit 18 is electrically connected to the main board 12 and the hub boards 44a, 44b, and 44c, and is adapted for providing electric power needed for operation of the main board 12 and the hub boards 44a, 44b, and 44c.

In conclusion, according to the computer hosts 10, 20, 30, and 40 provided in the disclosure, a main board may be connected to a hub board (or an expansion device) in a wireless connection manner instead of a conventional wired connection manner. In this way, connection lines between the hub board and the main board may be simplified, to avoid that excessive connection lines between the hub board and the main board cause difficulty in disassembling and assembling internal components and affect an internal heat dissipation effect and an overall appearance of the computer hosts 10, 20, 30, and 40.

The above is merely exemplary embodiments of the disclosure, and does not constitute any limitation on the disclosure. Any form of equivalent replacements or modifications to the technical means and technical content disclosed in the disclosure made by a person skilled in the art without departing from the scope of the technical means of the disclosure still fall within the content of the technical means of the disclosure and the protection scope of the disclosure.

What is claimed is:

1. A computer host, comprising:
a main board, comprising:
a main board wireless transmission module, adapted for generating a wireless control signal;
a hub board, comprising:
a hub board wireless transmission module, electrically connected to the main board wireless transmission module in a wireless manner, to receive the wireless control signal and generate a wired control signal based on the wireless control signal; and
an expansion connector, electrically connected to the hub board wireless transmission module, and adapted for transmitting the wired control signal; and
an expansion device, electrically connected to the expansion connector in a wired manner, and adapted for receiving the wired control signal and operating based on the wired control signal.

2. The computer host according to claim 1, further comprising a power supply unit, wherein the power supply unit is electrically connected to the hub board and is adapted for supplying power to the expansion device through the hub board.

3. The computer host according to claim 1, further comprising a power supply unit, wherein the power supply unit is electrically connected to the expansion device and is adapted for directly supplying power to the expansion device.

4. The computer host according to claim 1, wherein the expansion device is a heat dissipation fan, a control panel, or a light effect module.

5. The computer host according to claim 1, wherein the expansion device is a first expansion device, the expansion connector is a first expansion connector, the wired control signal is a first wired control signal, the computer host further comprises a second expansion device, the hub board further comprises a second expansion connector, the second expansion connector is electrically connected to the hub board wireless transmission module, the hub board wireless transmission module is adapted for generating the first wired control signal and a second wired control signal based on the wireless control signal, and the second expansion device is electrically connected to the second expansion connector in a wired manner, and is adapted for receiving the second wired control signal and operating based on the second wired control signal.

6. The computer host according to claim 5, wherein the first expansion device is a fan, and the second expansion device is a light effect module.

7. The computer host according to claim 1, wherein the expansion device is a first expansion device, the expansion connector is a first expansion connector, the wired control signal is a first wired control signal, the computer host further comprises a third expansion device, the hub board further comprises a third expansion connector, the third expansion connector is electrically connected to the hub board wireless transmission module, the third expansion device is electrically connected to the third expansion connector in a wired manner, the third expansion device is adapted for receiving an external control signal and transmitting the external control signal to the hub board wireless transmission module through the third expansion connector, and the hub board wireless transmission module is adapted for transmitting, in a wireless manner, the external control signal to the main board for processing.

8. The computer host according to claim 7, wherein the first expansion device is a fan, and the third expansion device is a control panel.

9. The computer host according to claim 1, wherein the main board wireless transmission module communicates with the hub board wireless transmission module through a proprietary radio frequency protocol.

10. The computer host according to claim 1, wherein the main board further comprises a processing unit, and the processing unit is electrically connected to the main board wireless transmission module and is adapted for generating the wired control signal.

11. The computer host according to claim 10, wherein the processing unit is electrically connected to the main board wireless transmission module through a universal serial bus (USB) 2.0 interface.
